(19) United States
(12) Patent Application Publication
(10) Pub. No.: US 2007/0134403 A1
(43) Pub. Date: Jun. 14, 2007

(54) Aqueous potassium lactate solution

(75) Inventors: Lonneke Van Dijk, Rotterdam (NL); Gema Rodriguez Longarela, Gorinchem (NL); Mirjam Sinnema, Rotterdam (NL); Kathleen Fahlin, Blair, NE (US)

Correspondence Address: OLIFF & BERRIDGE, PLC, P.O. BOX 19928, ALEXANDRIA, VA, 22320, US

(73) Assignee: PURAC BIOCHEM B.V., GORINCHEM (NL)

(21) Appl. No.: 11/605,965

(22) Filed: Nov. 30, 2006

Related U.S. Application Data
(60) Provisional application No. 60/740,630, filed on Nov. 30, 2005.

(51) Int. Cl. A23L 1/221

(52) U.S. Cl. 426/650

(57) ABSTRACT

The invention relates to a method for the preparation of an aqueous potassium lactate solution wherein a first potassium lactate solution having a potassium lactate concentration less than 65 wt. % is concentrated by evaporation to a solution having a potassium lactate concentration from 65 wt. % to 95 wt. %, which is subsequently. The method may be preceded or followed by treatment of the solution with active carbon.

The invention relates to a method for making an aqueous potassium lactate solution, to the solution thus obtained, and to a food or drink product containing the same.

Aqueous potassium lactate solutions are known in the art and are commercially available. Potassium lactate is a product that is mainly used in the meat industry. It is used for the same application as sodium lactate, namely for shelf life extension and safety enhancement. The use of potassium lactate is more and more preferred since it is believed that sodium lactate can cause hypertension. A disadvantage of such aqueous potassium lactate solutions is their undesirable flavors and odors, particularly causing a bitter aftertaste.

In WO 02/090311 and EP 1385815 a process for the removal of undesirable flavors and odors from potassium lactate was described by treating the potassium lactate solution with active carbon. The resulting potassium lactate is less bitter and has a more favorable flavor and odor profile and is thus accepted by a large part of the population. The potassium lactate is treated in the form of an aqueous solution. The concentration of potassium lactate in the solution to be treated is 40 to 80% by weight based on the combined weight of water and potassium lactate and the process can be carried out continuously or batch wise.

During the production of lactic acid by fermentation, normally neutralizing agents are used to neutralize the fermentation broth. In, for instance, GB 907,321 it has been described that calcium sulfate is used as neutralizing agent so that calcium lactate is formed. Afterwards, the calcium ions are replaced by hydrogen using ion exchange but these can also be replaced by sodium or potassium ions. Solutions thus obtained are not suitable for food applications since they contain substantial amounts of impurities such as ethanol, acetaldehyde, polysaccharides, diacetyl, 2-butanone, 2,3-pentanedione, and 2-butenal which cause bad odor and bad flavor. The free lactic acid, not its potassium salt, may be subjected to further purification and concentration.

A potassium lactate product that is purified according to prior art methods is, for instance, PURASAL HiPure® P, which is commercially available as a 60% solution by Purac Biochem BV, the Netherlands. When converting lactic acid to potassium lactate, theoretically higher concentrations than 60% can be obtained in this manner, but practically not. The reaction is highly exothermic and any attempt to make higher concentrations would inevitably lead to unacceptable unsafe reaction conditions, and further to formation of side products due to the excessive high temperatures.

The purification of potassium lactate solutions with the active carbon method according to the prior art has several drawbacks. Firstly, the active carbon treatment is expensive due to its elaborated and time-consuming regeneration, which adds considerable to the costs of the product that needs to be cheap for its intended use. Secondly, as the quality of the regenerated carbon of this process fluctuates, the quality of the potassium lactate also fluctuates. Thirdly, the flavor and odor properties of this product are still susceptible to improvement.

It is therefore an objective of the present invention to provide a simpler method that provides aqueous potassium lactate solutions with improved organoleptic properties, and wherein carbon, if used, can more easily be regenerated. The resulting aqueous potassium lactate solution is in a form which is ready for further application in food and drink products and does not require any further complex processing technique.

To this end the invention pertains to a method for the preparation of an aqueous potassium lactate solution wherein a first potassium lactate solution having a potassium lactate concentration less than 65 wt. % is concentrated by evaporation to a solution having a potassium lactate concentration from 65 wt. % to 85 wt. %, which is subsequently isolated.

The isolated product may be directly applied in food and drink products or may be packaged and shipped to customers for further applications in food and drink products. The product quality of the isolated product obtained by the present method was improved, as key aroma compounds appear to be removed from the product. The isolated product has a form which is suitable for further applications in various food and drink products, and particularly in meat and poultry, including fish.

Preferably, the potassium lactate solution is concentrated to a solution comprising 67 to 82 wt. %, more preferably 70 to 80 wt. %, and most preferably 76 to 79 wt. % of potassium lactate, since in above-mentioned concentration ranges a potassium lactate solution is obtained with an organoleptic profile that is optimal in terms of odor and taste sensation. Further, said product in above-mentioned ranges contains a minimum total concentration of key aroma compounds as ethanol, acetaldehyde, diacetyl, 2-butanone, 2,3-pentadione, and 2(E)-butenal. The total concentration of these key aroma compounds together is below 15 ppm, and even below 10 ppm for the 70 to 80 wt. % solutions. The ethanol concentration is less than 10 ppm for the above-mentioned potassium lactate concentration ranges and even below 5 ppm for solutions comprising 70 to 80 wt. % potassium lactate, which is a reduction of almost 10 times in comparison with commercially available potassium lactate solutions comprising 60 wt. % potassium lactate that were only carbon-treated.

Solutions with 76-79 wt. % potassium lactate content further show an optimum balance between the concentration and the viscosity of the potassium lactate solution. These solutions are therefore particularly efficient and suitable for further handling or application in food and drink products.

Since commercially available potassium lactate solutions commonly have a potassium lactate concentration of about 60 wt. %, it is preferred to use such solutions as the first (starting) potassium lactate solution.

In order to obtain higher quality products still having 60% potassium lactate, the first potassium lactate solution can be concentrated to a certain concentration between 65 and 85% and then diluted again to 60%.

Evaporation can be performed using any method for evaporation, such as distillation, flash distillation, wiped film distillation, short path distillation, vacuum distillation, rotary evaporation, spinning cone column evaporation, and the like. Sometimes it is preferred to perform the distillation in multiple, for instance two, separate distillation steps. In a first distillation step the first potassium lactate solution can be concentrated, for example, from 60% to 67%, and in a second distillation step this partially concentrated potassium lactate solution can be further concentrated from said 67% to, for example, 78%. If two distillation steps are used, it is further preferred to perform these steps in two different distillation units, but the evaporation can also take place in one apparatus because most evaporation apparatuses can be used as multi-step evaporator. As a suitable example the use of a plate evaporator is mentioned, wherein the liquid is pumped between thin plates with the heating medium on the mating surfaces, after which the product is evaporated with the vapor generated forming a high velocity core.

As explained, if possible, it is of advantage replacing the active carbon step by an evaporation step. However, due to coloring of the end product such step in some cases where further discolorization is desired may be still favorable. Such step can be performed prior to the evaporation step, for instance by using PURASAL HiPure P as the starting material, or alternatively the active carbon treatment can be performed after the evaporation step. It was found that such combined active carbon/evaporation method provides the highest quality end product. When performed prior to evaporation, it was found that a substantial improvement regarding taste and odor was achieved. When performed after evaporation, it was found that the regenerated carbon, and thus the resulting potassium lactate, showed less quality fluctuations.

It is a further objective of the invention to provide a method for purification removing bad flavor and/or bad odor from a first potassium lactate solution having a potassium lactate concentration less than 65% by evaporating said solution to a potassium lactate solution having a concentration from 65 to 85% t and optionally diluting said solution again, for instance to below 65%, or to about 60%.

It is also an objective of the invention to provide an aqueous potassium lactate solution having a potassium lactate concentration from 65 to 85%, and which is free from or at least poor in bad flavor and/or odor. Such product is obtainable by the above evaporation method with or without the additional active carbon purification step.

Concentrations higher than 85 wt. % lead to viscous solutions that are less suitable and more difficult to handle in for example meat production where low temperatures such as 4° C. are used, but are still suitable for transport. The concentrated solutions as obtained according to the invention may be diluted to any diluted concentration, for instance to a solution comprising a potassium lactate concentration of less than 65 wt. % or of about 60 wt. %. The higher concentration solutions, however, have the additional advantage that bulk amounts can more easily be transported because these need less container space for the same amount or potassium lactate.

Preferred potassium lactate solutions have a potassium lactate concentration of 67 to 82 wt. %, more preferably of 70 to 80 wt. %. A particularly useful concentration is 76 to 79 wt. % having the concentration of potassium lactate as high as possible, resulting in a very efficient solution without coming in conflict with a too high viscosity of the solution. Above-mentioned solutions are very suitable for handling and application in food or drink products and particularly in meat products. Said solutions further have a very low profile with respect to the presence of the following key aroma compounds: acetaldehyde, ethanol, diacetyl, 2-butanone, 2,3-pentadione and 1(E)-butenal. All these compounds together are present in a total content of less than 10 ppm in potassium lactate solutions of 76-79 wt. % as obtainable according to the method of the present invention.

It was further found that solutions with potassium lactate concentrations between 65 and 85 wt. % as obtainable by the evaporation method according to the present invention contained an ethanol concentration of less than 10 ppm. Potassium lactate solutions of between 70 and 80 wt. % contained even less than 5 ppm of ethanol.

The invention is further illustrated by the following non-limitative examples.

### EXPERIMENTAL

Five samples containing 60% of potassium lactate were evaporated by SPD (short path distillation) to obtain a concentrated solution.

The temperature of the heating oil was varied in order to obtain different concentrations. Table 1 gives the final concentration of the samples.

TABLE 1
Concentration of the samples

| Sample | Tₒᵢₗ [° C.] | Concentration [wt. %] |
|---|---|---|
| 1 | 100 | 67.1 |
| 2 | 115 | 70.6 |
| 3 | 145 | 78.1 |
| 4 | 160 | 82.1 |
| 5 | Reference* | 60.0 |

*PURASAL HiPure ® P; ex Purac America Inc., USA

GC-MS Results

The relative areas of key aroma compounds found by GS-MS are given in Table 2. The concentrated potassium lactate solutions were diluted to 60%, prior to analysis.

TABLE 2
Relative areas of key aroma compounds

| | Concentration (%) | | | | |
|---|---|---|---|---|---|
| | 60* | 67.1 | 70.6 | 78.1 | 82.1 |
| Acetaldehyde | 43.38 | 2.20 | 1.54 | 1.00 | 1.45 |
| Ethanol | 53.64 | 5.74 | 1.92 | 1.00 | 6.93 |
| Diacetyl | 3.46 | 1.00 | 1.03 | 1.34 | 1.92 |
| 2 Butanone | 37.21 | 1.00 | 1.18 | 1.06 | 1.14 |
| 2,3-Pentanedione | 7.79 | 1.22 | 1.09 | 1.00 | 1.51 |
| 2(E)-Butenal | 8.12 | 1.63 | 1.41 | 1.00 | 1.44 |
| Total | 153.60 | 12.78 | 8.17 | 6.40 | 14.39 |

*reference = PURASAL HiPure P

Taste and Odor

Odor and taste were tested by a sensory panel. Four samples were selected based on the GC-MS results. These samples were compared with a sample P-Lac®, 60% potassium lactate (ex Wilke Resources Inc., USA).

The samples for the odor test were diluted to 60% dry solids. The samples for taste were tested by diluting the samples to 1.12% dry solids. 6 Panel members judged the samples on taste and 4 panel members judged the samples on odor. The samples were ranked from 1 (low) to 5 (high).

Tables 3 and 4 show the results of the odor and taste tests, respectively.

TABLE 3
Results of odor

| Sample | Concentration (wt. %) | Average ranking* |
|---|---|---|
| 1 | 67.1 | 2.0 |
| 3 | 78.1 | 2.5 |
| 5# | 60.0 | 3.0 |
| P-Lac ® | 60.0 | 4.0 |

*1: low intensity, 5: high intensity
#PURASAL HiPure P (reference)

TABLE 4
Results of taste: intensity and bitterness

| | Concentration | Average ranking | Average ranking |
|---|---|---|---|
| Sample | (wt. %) | Intensity* | Bitterness* |
| 1 | 67.1 | 1.8 | 2.0 |
| 3 | 78.1 | 2.0 | 2.2 |
| 5# | 60.0 | 4.5 | 4.2 |
| P-Lac ® | 60.0 | 3.2 | 3.0 |

*1: low intensity; 5: high intensity
5 panel members ranked the samples on bitterness
#PURASAL HiPure ® P (reference)

1. A method for the preparation of an aqueous potassium lactate solution wherein a first potassium lactate solution having a potassium lactate concentration less than 65 wt. %, is concentrated by evaporation to a solution having a potassium lactate concentration from 65 wt. % to 85 wt. % which is subsequently isolated.

2. The method according to claim 1 wherein the first potassium lactate solution has a concentration of 60 wt. %.

3. The method according to claim 1 wherein the evaporation is performed in two steps, optionally in two distillation apparatuses.

4. The method according to claim 1 wherein the evaporation is performed by a plate evaporation process.

5. The method according to claim 1 wherein the evaporation is preceded or followed by treatment of the solution with active carbon.

6. The method according to claim 1 wherein the concentrated potassium lactate solution is diluted.

7. A potassium lactate solution obtainable by the method according to claim 1, the solution having an ethanol concentration less than 10 ppm.

8. The potassium lactate solution according to claim 7 having a potassium lactate concentration of 67 to 82 wt. %.

9. A food or drink product comprising the potassium lactate solution of claim 7.

10. The potassium lactate solution according to claim 7 having a potassium lactate concentration of 70-80 wt. %.

11. The potassium lactate solution according to claim 7 having a potassium lactate concentration of 76 to 79 wt. %.
